(19) United States
(12) Patent Application Publication
(10) Pub. No.: US 2018/0054324 A1
(43) Pub. Date: Feb. 22, 2018

(54) SYSTEM AND METHOD FOR INTEGRATING REDUNDANT RING AND RAPID SPANNING TREE PROTOCOL (RSTP)

(71) Applicant: MOXA INC., New Taipei City (TW)

(72) Inventors: Hsin-Jou YU, New Taipei City (TW); Chi-Chuan LIU, New Taipei City (TW); Yueh-Ming KO, New Taipei City (TW)

(21) Appl. No.: 15/242,601

(22) Filed: Aug. 22, 2016

(51) Int. Cl. H04L 12/42; H04L 12/24

(52) U.S. Cl. CPC H04L 12/422; H04L 41/12

(57) ABSTRACT

A system and method for integrating redundant ring and rapid spanning tree protocol (RSTP) are disclosed. By setting a mode message and a group ID for each of a plurality of ring nodes within a redundant ring, so that in a scenario that the redundant ring and the RSTP are running concurrently on a network environment, forwarding a bridge protocol data unit (BDPU) to a matching network topology is allowed when the mode message is transparent mode, and each of the respective network topology is converged to a steady state RSTP domain. The mechanism is help to improve the scalability of the network architecture.

### TECHNICAL FIELD

The present invention relates to a network system and a method thereof, and more particularly to a system and a method for integrating redundant ring and Rapid Spanning Tree Protocol (RSTP) that increase, in a group manner, a quantity of devices running the RSTP and allow a connection between a redundant ring and a device running the RSTP.

### BACKGROUND

In recent years, with popularity of the Internet, network topologies and network protocols become increasingly complex, or even can hardly be integrated, for example, a redundant ring protocol such as High-availability Seamless Redundancy (HSR) can hardly run concurrently with Rapid Spanning Tree Protocol (RSTP), leading to a failure of a redundancy mechanism of a whole network topology.

Generally, conventional devices running the RSTP can be connected by using any network topology. However, devices such as an intelligent electronic device (IED) or a programmable logic controller (PLC) are generally connected by means of a daisy chain, for example, and when the devices are connected to a switch, the switch also needs to run the RSTP, so as to form a large RSTP network. However, the RSTP has a maximum topology limit, causing that a network architecture is limited in size and cannot be expanded into a large network. In addition, when a network topology requirement changes, the network topology is also limited to being connected to a device running the RSTP, and there is a problem of poor scalability of the network architecture.

In view of the above, some manufactures propose to integrate a device running the RSTP with another ring, for example, Resilient Ethernet Protocol (REP), DT-Ring, S-Ring, MRP-Ring, and the like, so as to enable the redundancy mechanism and the RSTP to run concurrently. However, these manners are still limited to the maximum topology limit of the RSTP, and fail to effectively solve the problem of the poor scalability of the network architecture.

To sum up, it can be know that the problem of poor scalability of the network architecture has been existed in the prior art for a long time. Therefore, it is necessary to provide an improved technical means, so as to solve the problem.

### SUMMARY

The present invention discloses a system and a method for integrating redundant ring and Rapid Spanning Tree Protocol (RSTP).

First, the present invention discloses a system for integrating redundant ring and RSTP. The system includes: an HSR ring and a network topology. The HSR ring includes ring nodes. Each ring node includes a transmission module, a detection module, and a forwarding module. The transmission module is configured to transmit a Bridge Protocol Data Unit (BPDU) and includes: two first ports and a second port. Each of the two first ports is configured to be connected to one of two first ports of each of two different ring nodes, so as to form an HSR ring. The second port is configured to be connected to a first endpoint device or a second endpoint device running the RSTP, and is allowed to set a mode message and a group ID, where when the mode message is a transparent mode, forwarding the BPDU is allowed. The detection module is configured to detect, when the BPDU is received from the outside, a transmission source of the BPDU and a group to which the BPDU belongs. The forwarding module is configured to embed, when the transmission source is the second port, the group ID of the second port receiving the BPDU into the BPDU as the group to which the BPDU belongs, and forward the BPDU to the two first ports; and configured to compare, when the transmission source is one of the two first ports, the group to which the BPDU belongs with the group ID of the second port, and delete, if a comparison result is consistency, the group to which the BPDU belongs in the BPDU and forward the BPDU to the second port. With regard to the part of the network topology, each network topology includes at least a first endpoint device and a second endpoint device, and the first endpoint device and the second endpoint device of the network topology are separately connected to second ports with the same group ID in different ring nodes, so as to form a corresponding RSTP group.

In addition, the present invention further discloses a system for integrating redundant ring and Rapid Spanning Tree Protocol (RSTP), which is applied to a plurality of ring nodes that form a redundant ring. The system includes: a transmission module, a detection module, and a forwarding module. The transmission module is configured to transmit a Bridge Protocol Data Unit (BPDU) and includes two first ports and at least one second port. Each of the two first ports is configured to be connected to one of two first ports of each of two different ring nodes, so as to form the redundant ring. The second port is configured to be connected to a first endpoint device or a second endpoint device, running the RSTP, of a network topology, and is allowed to set a mode message and a group ID. When the mode message is a transparent mode, forwarding the BPDU is allowed. The first endpoint device and the second endpoint device of the network topology are separately connected to second ports with the same group ID, so as to form a corresponding RSTP group. The detection module is configured to detect, when the BPDU is received from the outside, a transmission source of the BPDU and a group to which the BPDU belongs. The forwarding module is configured to embed, when the transmission source is the second port, the group ID of the second port receiving the BPDU into the BPDU as the group to which the BPDU belongs; is configured to compare the group to which the BPDU belongs with a group ID of another second port, forward, if a comparison result is inconsistency, the BPDU to the first ports, and forward, if a comparison result is consistency, the BPDU to the consistent second port; and is configured to compare, when the transmission source is one the two first ports, the group to which the BPDU belongs with the group ID of the second port, forward, if a comparison result is inconsistency, the BPDU to the other first port, and delete, if a comparison result is consistency, the group to which the BPDU belongs in the BPDU and forward the BPDU to the consistent second port.

Subsequently, the present invention discloses a method for integrating redundant ring and Rapid Spanning Tree Protocol (RSTP), and steps of the method include: providing a High-availability Seamless Redundancy (HSR) ring, where the HSR ring includes a plurality of ring nodes, and each of two first ports of each ring node is connected to one of two first ports of each of two different ring nodes; connecting a second port of each ring node to a first endpoint device or a second endpoint device running the RSTP, and allowing the second port to set a mode message and a group ID, where when the mode message is a transparent mode, the second port allows forwarding of a Bridge Protocol Data Unit (BPDU); providing at least one network topology, where each network topology includes at least a first endpoint device and a second endpoint device, and the first endpoint device and the second endpoint device of the network topology are separately connected to second ports with the same group ID in different ring nodes, so as to form a corresponding RSTP group; detecting, when the ring node receives the BPDU from the outside, a transmission source of the BPDU and a group to which the BPDU belongs; embedding, when the transmission source is the second port, the group ID of the second port receiving the BPDU into the BPDU as the group to which the BPDU belongs by the ring node, and forwarding the BPDU to the two first ports; and comparing, when the transmission source is one of the two first ports, the group to which the BPDU belongs with the group ID of the second port, forwarding, if a comparison result is inconsistency, the BPDU to the other first port, and deleting, if a comparison result is consistency, the group to which the BPDU belongs in the BPDU and forwarding the BPDU to the second port.

In addition, the present invention further discloses a method for method for integrating redundant ring and Rapid Spanning Tree Protocol (RSTP), which is applied to a plurality of ring nodes that form a redundant ring, where each ring node includes two first ports and at least one second port; each of the two first ports is connected to one of two first ports of each of two different ring nodes; the second port is connected to a first endpoint device or a second endpoint device, running the RSTP, of a network topology; the first endpoint device and the second endpoint device of the network topology are separately connected to second ports with the same group ID, so as to form a corresponding RSTP group; and steps of the method include: allowing the second port by the ring node to set a mode message and the group ID, where when the mode message is a transparent mode, the second port allows forwarding of a Bridge Protocol Data Unit (BPDU); detecting, when the ring node receives the BPDU from the outside, a transmission source of the BPDU and a group to which the BPDU belongs; embedding, when the transmission source is the second port, the group ID of the second port receiving the BPDU into the BPDU as the group to which the BPDU belongs by the ring node, and comparing the group to which the BPDU belongs with a group ID of another second port, forwarding, if a comparison result is inconsistency, the BPDU to the first ports, and forwarding, if a comparison result is consistency, the BPDU to the consistent second port; and comparing, when the transmission source is one of the two first ports, the group to which the BPDU belongs with the group ID of the second port by the ring node, forwarding, if a comparison result is inconsistency, the BPDU to the other first port, and deleting, if a comparison result is consistency, the group to which the BPDU belongs in the BPDU and forwarding the BPDU to the consistent second port.

The systems and methods disclosed by the present invention are described as above, and differ from the prior art in that a mode message and a group ID are set for a ring node of a redundant ring, such that in a network environment in which redundant ring and RSTP run concurrently, the ring node allows, according to the group ID when the mode message is a transparent mode, forwarding of a BPDU to a consistent network topology, and each network topology is converged to a steady state RSTP domain.

By means of the foregoing technical means, the present invention can achieve the technical effect of improving the scalability of the network architecture.

### BRIEF DESCRIPTION OF THE DRAWING

FIG. 1 is a block diagram of a system for integrating redundant ring and RSTP according to the present invention;

FIG. 2A and FIG. 2B are a flowchart of a method for integrating redundant ring and RSTP according to the present invention;

FIG. 3 is a block diagram of another system for integrating redundant ring and RSTP according to the present invention;

FIG. 4 is a flowchart of another method for integrating redundant ring and RSTP according to the present invention;

FIG. 5 is a schematic diagram of communication between virtual local area networks (VLANs) and RSTP groups carried out by using the present invention; and

FIG. 6 is a schematic diagram of setting a mode message and a group ID by using the present invention.

### DETAILED DESCRIPTION

Implementation of the present invention is illustrated below in detail with reference to the drawings and embodiments, so as to enable an implementation process, in which the present invention applies the technical means to solve the technical problem and achieve the technical effect, to be fully understood and implemented accordingly.

Before the system and the method for integrating redundant ring and RSTP disclosed by the present invention are described, first, terms defined by the present invention are described. A first port in the present invention refers to a port that is used in forming a redundant ring, and a second port in the present invention refers to a port for connecting a network topology to a switch. In practical implementation, one end of a network topology connected to a redundant ring is called a first endpoint device, and the other end of the network topology connected to the redundant ring is called a second endpoint device; and a second port is a port connected to the first endpoint device or the second endpoint device. In addition, in a transparent mode of the present invention, forwarding a BPDU to a port capable of forwarding is allowed, but a BPDU is not forwarded to a blocking port, and an RSTP is not processed, that is, a second port is in a state of the RSTP being closed. It should be noted that, a device such as the IED or the PLC is preset in a state of the RSTP being opened, but a second port of a ring node (alternatively called a switch) on a redundant ring can form a corresponding RSTP group with the device such as the IED or the PLC in a network topology only when the second port is in a state of the RSTP being closed, so as to prevent all the network topologies from forming a same RSTP group. If the second port opens the RSTP, at this time, the second port is unable to form corresponding RSTP groups for different network topologies, and when the ring node receives bridge protocol data, the ring node forwards the bridge protocol data according to the normal RSTP.

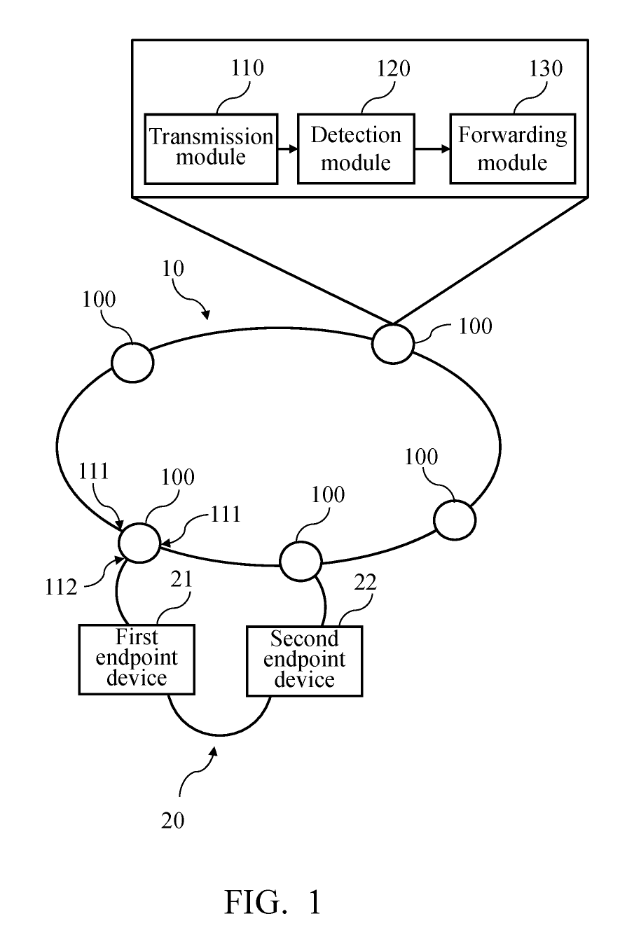

The following further describes the system and method for integrating redundant ring and RSTP of the present invention with reference to drawings. Referring to FIG. 1, FIG. 1 is a block diagram of a system for integrating redundant ring and RSTP according to the present invention. The system includes: an HSR ring 10 and a network topology 20. The HSR ring 10 includes a plurality of ring nodes 100. In practical implementation, a ring node 100 is a switch or a computer device with a same function. In addition, each device in the network topology 20 runs the RSTP, and includes at least a first endpoint device 21 and a second endpoint device 22. The first endpoint device 21 and the second endpoint device 22 of the network topology are separately connected to second ports 112 with a same group ID in different ring nodes 100, so as to form a corresponding RSTP group, and the RSTP group corresponds to the group ID of the second ports. Instead of using a same root, the RSTP groups with different group IDs have respective RSTP roots. Therefore, a quantity of devices in each RSTP group can achieve a maximum topology limit of the RSTP, thereby improving the scalability of the network architecture. The first endpoint device 21 and the second endpoint device 22 may be computer devices running the RSTP, for example, IED, PLC, and the like. It should be noted that although the network topology 20 shown in FIG. 1 is a chain network, the type of the network topology 20 of the present invention is not limited thereto. In other words, any network topology capable of running the RSTP falls within the application scope of the present invention.

With regard to the part of the ring nodes 100, each ring node 100 includes: a transmission module 110, a detection module 120, and a forwarding module 130. The transmission module 110 is configured to transmit a BPDU, and the transmission module 110 includes: two first ports 111 and a second port 112. Each of the two first ports 111 is connected to one of two first ports 111 of each of two different ring nodes 100, so as to form the HSR ring 10. The second port 112 is configured to be connected to the first endpoint device 21 or the second endpoint device 22 running the RSTP, and is allowed to set a mode message and a group ID. When the mode message is a transparent mode, the second port 112 is in a state of the RSTP being closed, and forwarding the BPDU is allowed. When the mode message is not a transparent mode and the second port 112 closes the RSTP, the second port 112 drops the received BPDU. It should be noted that when the mode message is not the transparent mode, if the BPDU is received by one first port 111, the ring node 100 directly forwards the BPDU received from the first port 111 to the other first port 111.

The detection module 120 is configured to detect, when the BPDU is received from the outside, a transmission source of the BPDU and a group to which the BPDU belongs. The outside refers to the outside of the device of the ring node 100. Therefore, both of the HSR ring 10 and the network topology 20 are located at the outside of the ring node 100. In practical implementation, the detection of a transmission source is determined by a particular port that receives the BPDU; the transmission source being the first port 111 represents that the BPDU is from the HSR ring 10; and the transmission source being the second port 112 represents that the BPDU is from the network topology 20. In addition, the detection of a group to which the BPDU belongs is determined by system ID extension, and the system ID extension is of 12 bits and records a group ID. Therefore, the group to which the BPDU belongs can be acquired by reading the group ID. It should be noted that, if the transmission source is the second port 112, at this time, the group ID is not embedded into the BPDU, and therefore, the group to which the BPDU belongs is determined by the group ID of the second port 112.

The forwarding module 130 is configured to embed, when the transmission source is the second port 112, the group ID of the second port 112 receiving the BPDU into the BPDU, where the group with the group ID is the group to which the BPDU belongs, and forward the BPDU to the two first ports 111; and is configured to compare, when the transmission source is one of the two first ports 111, the group to which the BPDU belongs with the group ID of the second port 112, forward, if a comparison result is inconsistency, the BPDU to the other first port 111, and delete, when a comparison result is consistency, the group to which the BPDU belongs in the BPDU and forward the BPDU to the second port 112. The network topologies 20 are grouped according to group IDs. Therefore, even in a case in which the HSR and the RSTP run concurrently, a network breakdown caused by occupation of an overall network by a broadcast packet or a multicast packet can be effectively avoided.

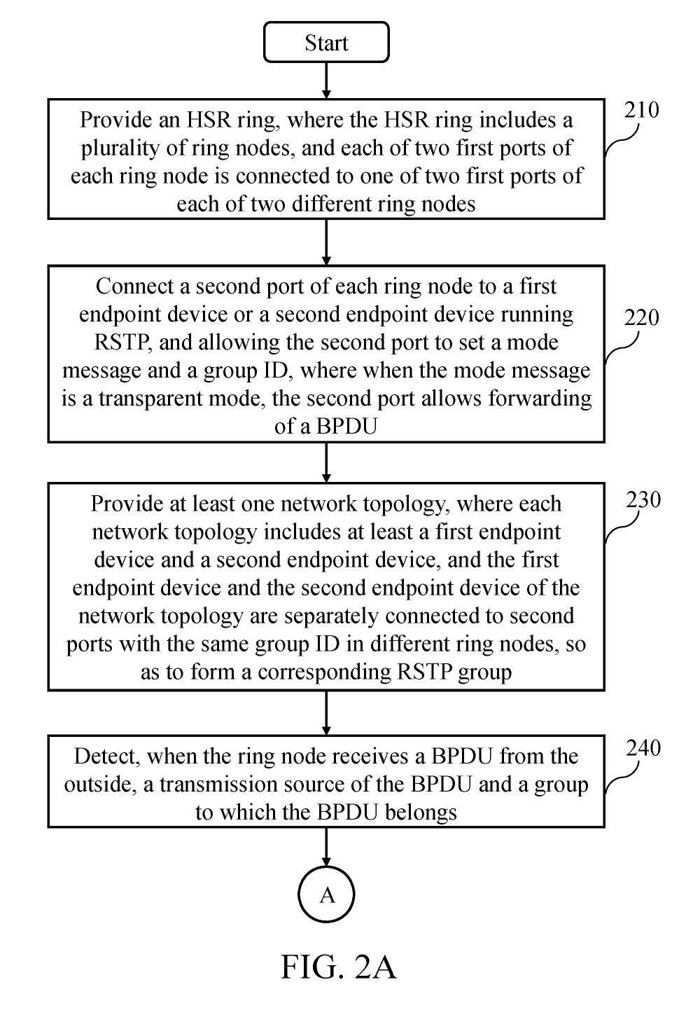

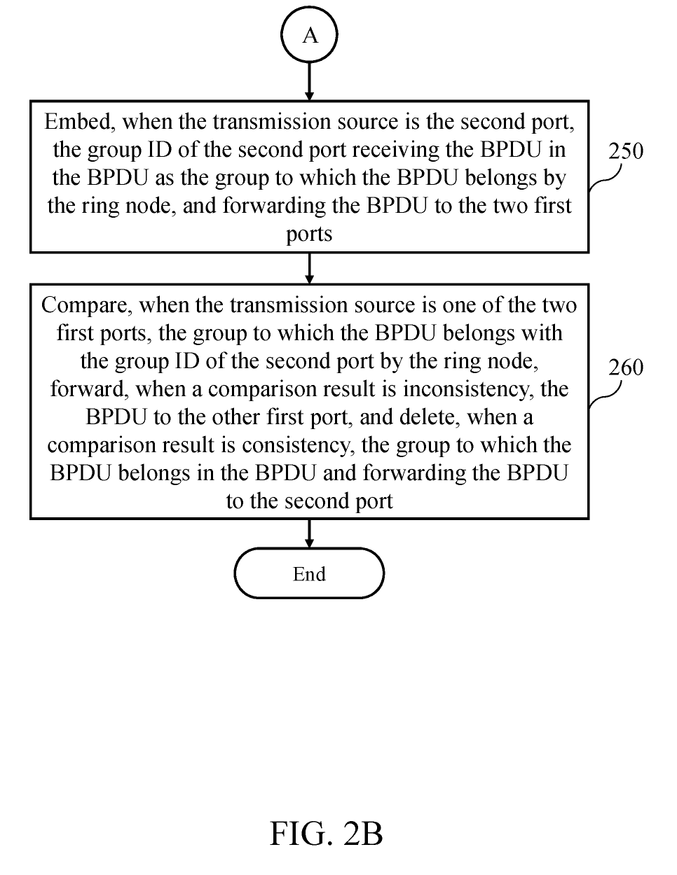

Subsequently, referring to FIG. 2A and FIG. 2B, FIG. 2A and FIG. 2B are a flowchart of a method for integrating redundant ring and RSTP, and steps of the method include: providing an HSR ring 10, where the HSR ring 10 includes a plurality of ring nodes 100, and each of two first ports 111 of each ring node 100 is connected to one of two first ports 111 of each of two different ring nodes 100 (step 210); connecting a second port 112 of each ring node 100 to a first endpoint device 21 or a second endpoint device 22 running the RSTP, and allowing the second port 112 to set a mode message and a group ID, where when the mode message is a transparent mode, the second port 112 allows forwarding of a BPDU (step 220); providing at least one network topology 20, where each network topology 20 includes at least a first endpoint device 21 and a second endpoint device 22, and the first endpoint device 21 and the second endpoint device 22 of the network topology 20 are separately connected to second ports 112 with the same group ID in different ring nodes 100, so as to form a corresponding RSTP group (step 230); detecting, when the ring node 100 receives a BPDU from the outside, a transmission source of the BPDU and a group to which the BPDU belongs (step 240); embedding, when the transmission source is the second port 112, the group ID of the second port 112 receiving the BPDU into the BPDU as the group to which the BPDU belongs by the ring node 100, and forwarding the BPDU to the two first ports 111 (step 250); and comparing, when the transmission source is one of the two first ports 111, the group to which the BPDU belongs with the group ID of the second port 112 by the ring node, forwarding, when a comparison result is inconsistency, the BPDU to the other first port 111, and deleting, when a comparison result is consistency, the group to which the BPDU belongs in the BPDU and forwarding the BPDU to the second port (step 260). By means of the foregoing steps, a mode message and a group ID are set for the ring node 100 of the HSR ring 10, such that in a network environment in which the HSR ring 10 and the RSTP run concurrently, the ring node 100 allows, according to the group ID when the mode message is a transparent mode, forwarding of a BPDU to a consistent network topology 20, and each network topology 20 is converged to a steady state RSTP domain.

It should be additionally noted that in step 220, when the mode message is not a transparent mode and the second port 112 closes the RSTP, the BPDU received by the second port 112 may be directly discarded, and the BPDU received by one first port 111 is forwarded to the other first port 111.

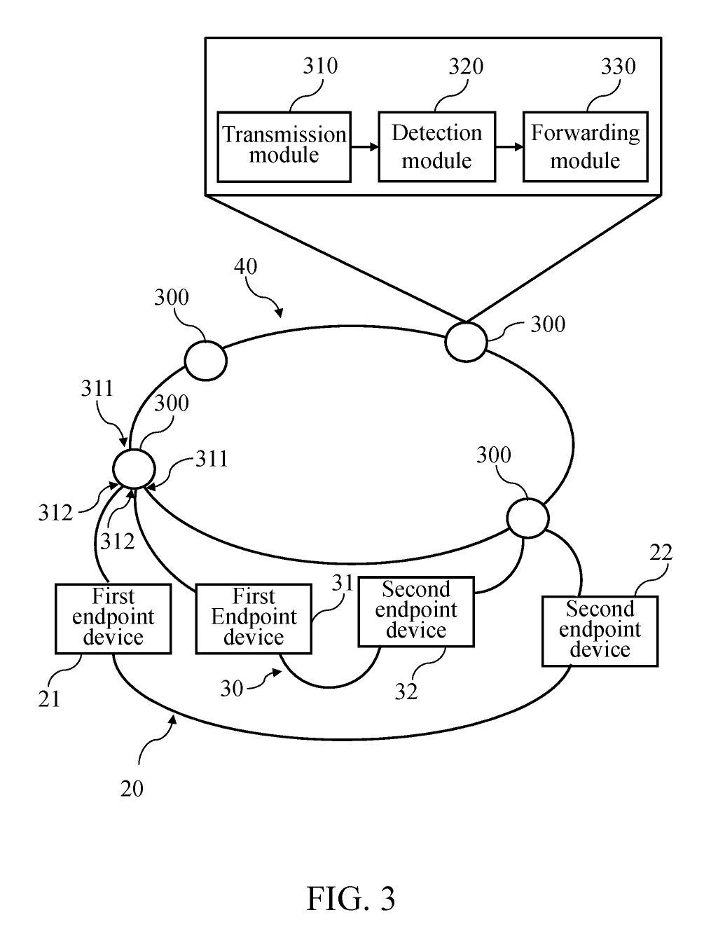

Subsequently, referring to FIG. 3, FIG. 3 is a block diagram of another system for integrating redundant ring and RSTP according to the present invention. The system is applied to ring nodes 300 of a redundant ring 40. The system includes: a transmission module 310, a detection module 320, and a forwarding module 330. The transmission module 310 is configured to transmit a BPDU and includes two first ports 311 and at least one second ports 312. Each of the two first ports 311 is configured to be connected to one of two first ports 311 of each of two different ring nodes 300, so as to form the redundant ring 40. Each second port 312 is configured to be connected to a first endpoint device (21, 22) or a second endpoint device (31, 32), running the RSTP, of a network topology (20, 30), and is allowed to set a mode message and a group ID, where when the mode message is a transparent mode, forwarding a BPDU is allowed; and the first endpoint device (21, 22) and the second endpoint device (31, 32) of the network topology (20, 30) are separately connected to second ports 312 with the same group ID, so as to form a corresponding RSTP group. The transmission module 310 is similar to the transmission module 110 shown in FIG. 1, and differs from the transmission module 110 shown in FIG. 1 in that a ring node 300 may have a plurality of second ports 312, and the first ports 311 are connected to the redundant ring 40 rather than the HSR ring 10 shown in FIG. 1.

The detection module 320 is configured to detect, when the BPDU is received from the outside, a transmission source of the BPDU and a group to which the BPDU belongs. The detection module 320 here is the same as the detection module 120 shown in FIG. 1, and is not described in detail herein again.

The forwarding module 330 is configured to embed, when the transmission source is the second port 312, the group ID of the second port 312 receiving the BPDU into the BPDU, where the group with the group ID is the group to which the BPDU belongs; is configured to compare the group to which the BPDU belongs with a group ID of another second port 312, forward, if a comparison result is inconsistency, the BPDU to the first ports 311, and forward, if a comparison result is consistency, the BPDU to the consistent second port 312; and is configured to compare, when the transmission source is one the two first ports 311, the group to which the BPDU belongs with the group ID of the second port 312, forward, if a comparison result is inconsistency, the BPDU to the other first port 311, and delete, if a comparison result is consistency, the group to which the BPDU belongs in the BPDU and forward the BPDU to the consistent second port 312. In other words, the forwarding module 330 performs corresponding forwarding according to a port receiving the BPDU. If a port receiving the BPDU is the second port 312, the group ID of the second port 312 is embedded (alternatively called labeled) in a packet. If a group ID of another second port 312 on the ring node 300 is the same as the group ID of the second port 312, the BPDU is forwarded to the second port 312 having the same group ID, and otherwise, the BPDU is forwarded to the first ports 311. If a port receiving the BPDU is one of the first ports 311, it is checked whether the group to which the BPDU belongs that is embedded in a packet is the same as the group ID of the second port 312 on the ring node 300, and if yes, the group ID of the packet is removed, and the BPDU is forwarded to the second port 312 with the same group ID, and otherwise, the BPDU is forwarded to the other first port 311. The forwarding module 330 is similar to the forwarding module 330 shown in FIG. 1, and differs from the forwarding module 130 shown in FIG. 1 in that determining group IDs of a plurality of second ports 312 is added, and a corresponding forwarding process is performed on the basis of a determining result.

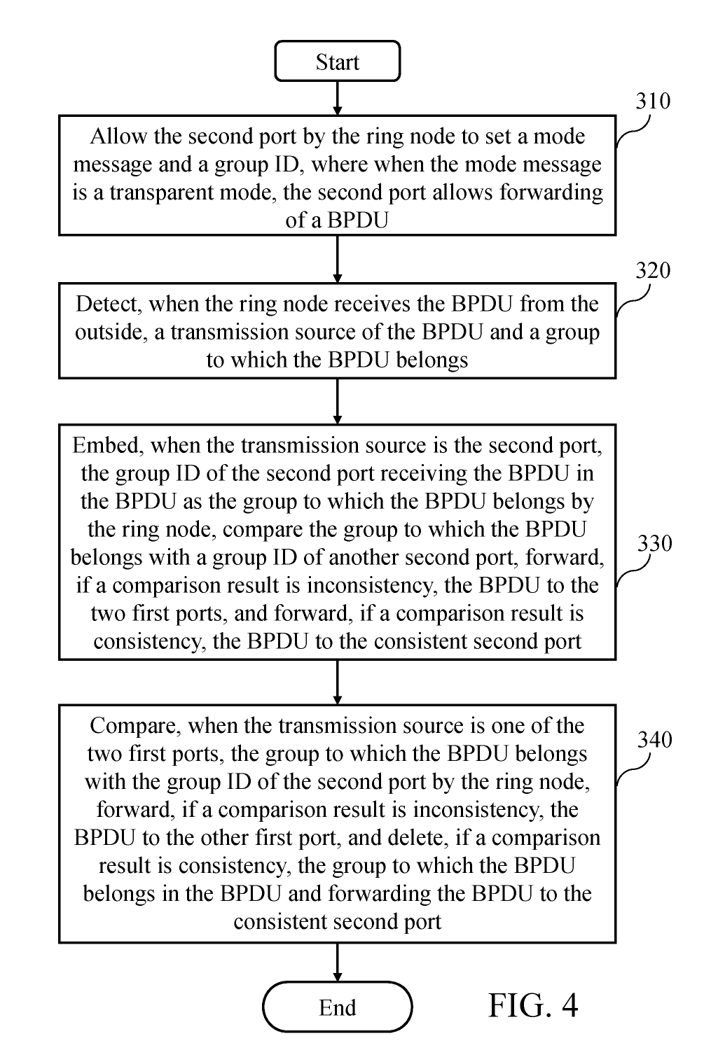

As shown in FIG. 4, FIG. 4 is a flowchart of another method for integrating redundant ring and RSTP according to the present invention. The method is applied to a plurality of ring nodes 300 that form a redundant ring 40, where each ring node 300 includes two first ports 311 and at least one second port 312; each of the two first ports 311 is connected to one of two first ports 311 of each of two different ring nodes 300; the second port 312 is connected to a first endpoint device (21, 32) or a second endpoint device (22, 32), running the RSTP, of a network topology (20, 30); the first endpoint device (21, 31) and the second endpoint device (22, 32) of the network topology (20, 30) are separately connected to second ports 312 with the same group ID, so as to form a corresponding RSTP group; and steps of the method include: allowing the second port 312 by the ring node 300 to set a mode message and a group ID, where when the mode message is a transparent mode, the second port 312 allows forwarding of a BPDU (step 310); detecting, when the ring node 300 receives a BPDU from the outside, a transmission source of the BPDU and a group to which the BPDU belongs (step 320); embedding, when the transmission source is the second port 312, the group ID of the second port 312 receiving the BPDU into the BPDU as the group to which the BPDU belongs by the ring node 300, comparing the group to which the BPDU belongs with a group ID of another second port 312, forwarding, if a comparison result is inconsistency, the BPDU to the first ports 311, and forwarding, if a comparison result is consistency, the BPDU to the consistent second port 312 (step 330); and comparing, when the transmission source is one of the two first ports 311, the group to which the BPDU belongs with the group ID of the second port 312 by the ring node 300, forwarding, if a comparison result is inconsistency, the BPDU to the other first port 311, and deleting, if a comparison result is consistency, the group to which the BPDU belongs in the BPDU and forwarding the BPDU to the consistent second port 312 (step 340). By means of the foregoing steps, a mode message and a group ID are set for the ring node 300 of the HSR ring 40, such that in a network environment in which the HSR ring 40 and the RSTP run concurrently, the ring node 300 allows, according to the group ID when the mode message is a transparent mode, forwarding of a BPDU to a consistent network topology (20, 30), and each network topology (20, 30) is converged to a steady state RSTP domain. In practical implementation, the mode message and the group ID are set by logging in the ring node 300 and using a preset graphical user interface or instruction, which is described later with reference to the drawings.

It should be additionally noted that in step 310, when the mode message is not a transparent mode and the second port 312 closes the RSTP, the BPDU received by the second port 312 may be directly discarded, and the BPDU received by one of the two first port 311 is forwarded to the other first port 311.

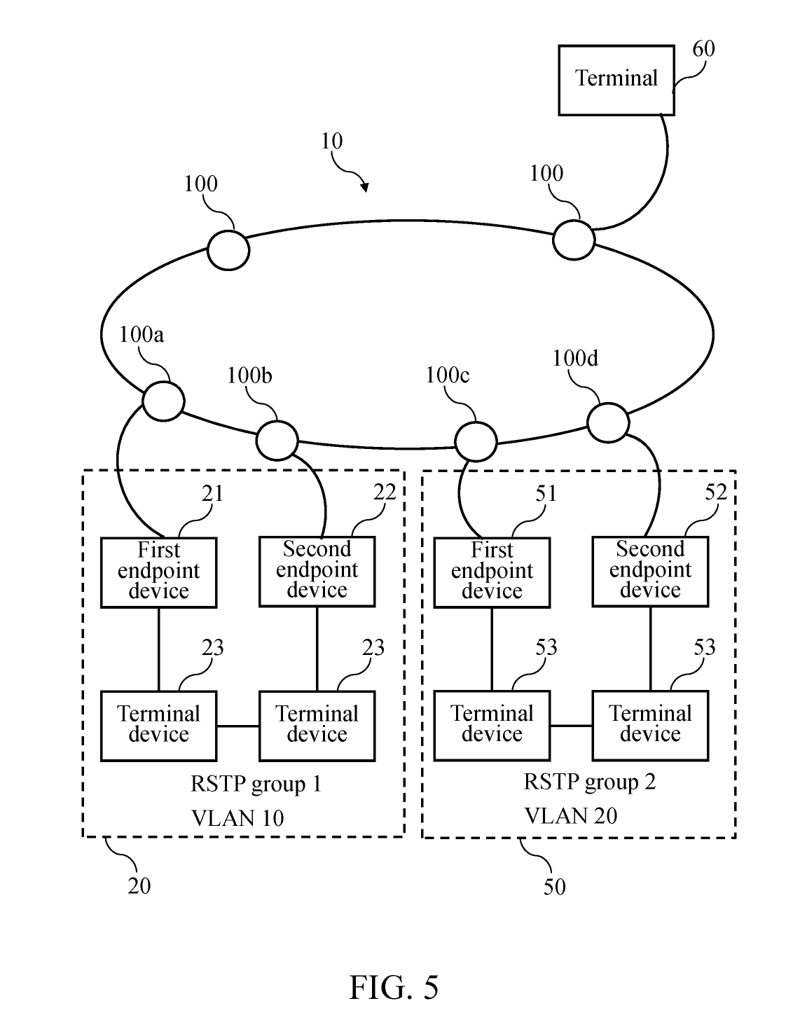

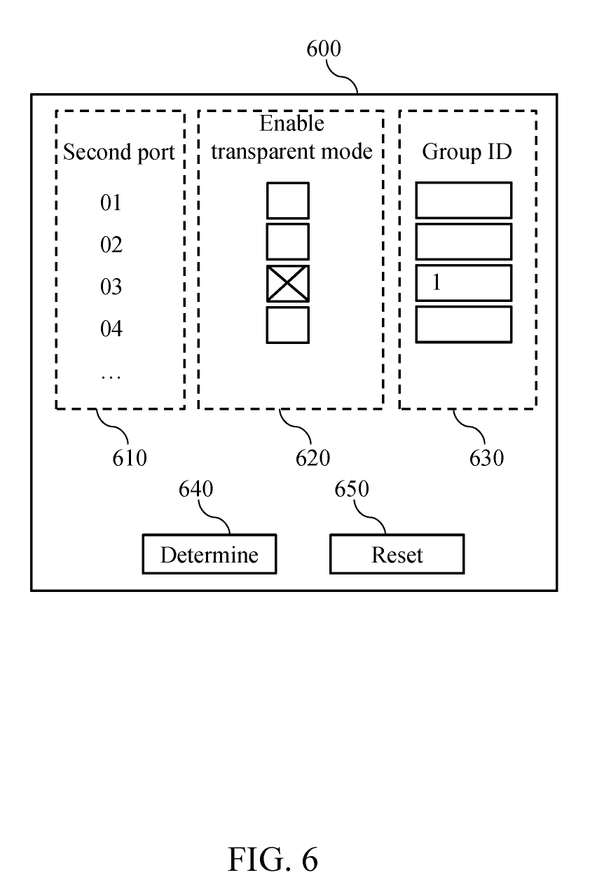

The following description is made in a manner of embodiments with reference to FIG. 5 and FIG. 6. First, referring to FIG. 5, FIG. 5 is a schematic diagram of communication between VLANs and RSTP groups carried out by using the present invention. It is mentioned earlier that a network topology 20 includes a first endpoint device 21 and a second endpoint device 22. However, in practical implementation, the network topology 20 may further include a plurality of terminal devices 23. Besides, the HSR ring 10 may be further connected to a plurality of network topologies, for example, a network topology 50. The network topology 50 also includes a first endpoint device 21, a second endpoint device 22, and terminal devices 23. Different network topologies may be connected to adjacent ring nodes, as shown in FIG. 5, the network topology 20 is connected to adjacent ring nodes (100a, 100b), and the network topology 50 is connected to adjacent ring nodes (100c, 100d). Subsequently, an RSTP group (that is, a network topology) may work with a VLAN to manage a network, and each RSTP group corresponds to a VLAN, for example, a VLAN of an “RSTP group 1” is a “VLAN 10”, and a VLAN of an “RSTP group 2” is a “VLAN 20”. When a terminal 60 that is also in the “VLAN 20” intends to communicate with a device in the network topology 20, before the “RSTP group 1” is distinguished from the “RSTP group 2”, such a connection manner causes a failure of an RSTP mechanism even though the VLANs are used for separation, and all ports are in states of forwarding, which works together with the HSR ring 10, leading to a network breakdown caused by occupation of an overall network by broadcast and multicast packets. After the “RSTP group 1” is distinguished from the “RSTP group 2”, when a BPDU is forwarded, the BPDU may be only forwarded to a same RSTP group according to a group ID, for example, a BPDU received by the ring node 100c from the network topology 50 is transmitted by using the HSR ring 10, and besides the ring node 100d, other ring nodes (100a and 100b) do not forward the BPDU to the network topology 20. Therefore, each network topology (20, 50) is converged to a steady state RSTP domain.

As shown in FIG. 6, FIG. 6 is a schematic diagram of setting a mode message and a group ID by using the present invention. In practical implementation, a mode message and a group ID of a second port of a ring node are set by logging in a graphical user interface 600 displayed on the ring node. After logging in the ring node, a user may select, according to a port number of a second port displayed on a port number display block 610, to set a corresponding mode message and a group ID in a mode setting block 620 and a group setting block 630, for example, a ring node has a plurality of second ports, and a user needs to be in a third enable transparent mode and to set a group ID as a value 1. At this time, as shown in FIG. 6, a corresponding selection block in the mode setting block 620 is set by using a cursor click mode, a value 1 is typed into a corresponding place in the group setting block 630, and a determining element 640 is clicked, so as to complete the setting. If resetting is needed, a resetting element 650 may be clicked to restore to factory reset.

To sum up, it can be known that the present invention differs from the prior art in that, a mode message and a group ID are set for each ring node of a redundant ring, such that in a network environment in which the redundant ring and the RSTP run concurrently, the ring node allows, when the mode message is a transparent mode, to forward, according to the group ID, a BPDU to a consistent network topology, and enables each network topology to be converged to a steady state RSTP domain. By means of this technical means, the problem that a redundant ring and an RSTP cannot run concurrently existing in the prior art can be resolved, thereby achieving the technical effect of improving the scalability of the network architecture.

What is claimed is:

1. A system for integrating redundant ring and Rapid Spanning Tree Protocol (RSTP), comprising:
a High-availability Seamless Redundancy (HSR) ring, wherein the HSR ring comprises a plurality of ring nodes, and each ring node comprises:
a transmission module, configured to transmit a Bridge Protocol Data Unit (BPDU), and the transmission module comprises:
two first ports, each configured to be connected to one of two first ports of each of two different ring nodes, so as to form the HSR ring; and
a second port, configured to be connected to a first endpoint device or a second endpoint device running the RSTP, and allowed to set a mode message and a group ID, wherein when the mode message is a transparent mode, forwarding the BPDU is allowed;
a detection module, configured to detect, when the BPDU is received from the outside, a transmission source of the BPDU and a group to which the BPDU belongs; and
a forwarding module, configured to embed, when the transmission source is the second port, the group ID of the second port receiving the BPDU into the BPDU, wherein the group with the group ID is the group to which the BPDU belongs, and configured to forward the BPDU to the two first ports; and configured to compare, when the transmission source is one of the two first ports, the group to which the BPDU belongs with the group ID of the second port, and delete, if a comparison result is consistency, the group to which the BPDU belongs in the BPDU and forward the BPDU to the second port; and
at least one network topology, wherein each network topology comprises at least a first endpoint device and a second endpoint device; and the first endpoint device and the second endpoint device of the network topology are separately connected to second ports with the same group ID in different ring nodes, so as to form a corresponding RSTP group.

2. The system for integrating redundant ring and RSTP according to claim 1, wherein when the mode message is not a transparent mode and the second port closes the RSTP, the second port drops the BPDU.

3. The system for integrating redundant ring and RSTP according to claim 2, wherein when the mode message is not a transparent mode, the BPDU received from one of the two first ports is directly forwarded to the other first port.

4. The system for integrating redundant ring and RSTP according to claim 1, wherein the RSTP group corresponds to the group ID of the second port, and different RSTP groups of the group ID respectively have RSTP roots.

5. The system for integrating redundant ring and RSTP according to claim 1, wherein the forwarding module compares, when the transmission source is one of the two first ports, the group to which the BPDU belongs with the group ID of the second port, and forwards, if a comparison result is inconsistency, the BPDU to the other first port.

6. A system for integrating redundant ring and Rapid Spanning Tree Protocol (RSTP), which is applied to a plurality of ring nodes that form a redundant ring, wherein the system comprises:
a transmission module, configured to transmit a Bridge Protocol Data Unit (BPDU), and the transmission module comprises:
two first ports, each configured to be connected to one of two first ports of each of two different ring nodes, so as to form the redundant ring; and
at least one second port, each configured to be connected to a first endpoint device or a second endpoint device, running the RSTP, of a network topology, and each allowed to set a mode message and a group ID, wherein when the mode message is a transparent mode, forwarding the BPDU is allowed; and the first endpoint device and the second endpoint device of the network topology are separately connected to second ports with the same group ID, so as to form a corresponding RSTP group;
a detection module, configured to detect, when the BPDU is received from the outside, a transmission source of the BPDU and a group to which the BPDU belongs; and
a forwarding module, configured to embed, when the transmission source is the second port, the group ID of the second port receiving the BPDU into the BPDU, wherein the group with the group ID is the group to which the BPDU belongs; configured to compare the group to which the BPDU belongs with a group ID of another second port, and forward, if a comparison result is consistency, the BPDU to the consistent second port; and configured to compare, when the transmission source is one the two first ports, the group to which the BPDU belongs with the group ID of the second port, and delete, if a comparison result is consistency, the group to which the BPDU belongs in the BPDU and forward the BPDU to the consistent second port.

7. The system for integrating redundant ring and RSTP according to claim 6, wherein the forwarding module embeds, when the transmission source is the second port, the group ID of the second port receiving the BPDU into the BPDU as the group to which the BPDU belongs, compares the group to which the BPDU belongs with a group ID of another second port, and forwards, if a comparison result is inconsistency, the BPDU to the two first ports.

8. The system for integrating redundant ring and RSTP according to claim 6, wherein the forwarding module compares, when the transmission source is one of the two first ports, the group to which the BPDU belongs with the group ID of the second port, and forwards, if a comparison result is inconsistency, the BPDU to the other first port.

9. The system for integrating redundant ring and RSTP according to claim 6, wherein the first endpoint device and the second endpoint device of the network topology are separately connected to second ports with the same group ID in different ring nodes, so as to form a corresponding RSTP group.

10. A method for integrating redundant ring and Rapid Spanning Tree Protocol (RSTP), comprising steps of:
providing a High-availability Seamless Redundancy (HSR) ring, wherein the HSR ring comprises a plurality of ring nodes, and each of two first ports of each ring node is connected to one of two first ports of each of two different ring nodes;
connecting a second port of each ring node to a first endpoint device or a second endpoint device running the RSTP, and allowing the second port to set a mode message and a group ID, wherein when the mode message is a transparent mode, the second port allows forwarding of a Bridge Protocol Data Unit (BPDU);
providing at least one network topology, wherein each network topology comprises at least a first endpoint device and a second endpoint device, and the first endpoint device and the second endpoint device of the network topology are separately connected to second ports with the same group ID in different ring nodes, so as to form a corresponding RSTP group;
detecting, when the ring node receives the BPDU from the outside, a transmission source of the BPDU and a group to which the BPDU belongs;
embedding, when the transmission source is the second port, the group ID of the second port receiving the BPDU into the BPDU by the ring node, wherein the group with the group ID is the group to which the BPDU belongs, and forwarding the BPDU to the two first ports; and
comparing, when the transmission source is one of the two first ports, the group to which the BPDU belongs with the group ID of the second port, and deleting, if a comparison result is consistency, the group to which the BPDU belongs in the BPDU and forwarding the BPDU to the second port.

11. The method for integrating redundant ring and RSTP according to claim 10, wherein when the mode message is not a transparent mode and the second port closes the RSTP, the second port drops the BPDU.

12. The method for integrating redundant ring and RSTP according to claim 11, wherein when the mode message is not a transparent mode, the BPDU received from one of the two first ports is directly forwarded to the other first port.

13. The method for integrating redundant ring and RSTP according to claim 10, wherein the RSTP group corresponds to the group ID of the second port, and different RSTP groups of the group ID respectively have RSTP roots.

14. The method for integrating redundant ring and RSTP according to claim 10, wherein when the transmission source is one of the two first ports, compares the group to which the BPDU belongs with the group ID of the second port, and forwards, if a comparison result is inconsistency, the BPDU to the other first port.

15. A method for integrating redundant ring and Rapid Spanning Tree Protocol (RSTP), which is applied to a plurality of ring nodes that form a redundant ring, wherein each ring node comprises two first ports and at least one second port; each of the two first ports is connected to one of two first ports of each of two different ring nodes; the second port is connected to a first endpoint device or a second endpoint device, running the RSTP, of a network topology; the first endpoint device and the second endpoint device of the network topology are separately connected to second ports with the same group ID, so as to form a corresponding RSTP group; and the method comprises steps of:
allowing the second port by the ring node to set a mode message and a group ID, wherein when the mode message is a transparent mode, the second port allows forwarding of a Bridge Protocol Data Unit (BPDU);
detecting, when the ring node receives the BPDU from the outside, a transmission source of the BPDU and a group to which the BPDU belongs;
embedding, when the transmission source is the second port, the group ID of the second port receiving the BPDU into the BPDU by the ring node, wherein the group with the group ID is the group to which the BPDU belongs, and comparing the group to which the BPDU belongs with a group ID of another second port, and forwarding, if a comparison result is consistency, the BPDU to the consistent second port; and
comparing, when the transmission source is one of the two first ports, the group to which the BPDU belongs with the group ID of the second port by the ring node, and deleting, if a comparison result is consistency, the group to which the BPDU belongs in the BPDU and forwarding the BPDU to the consistent second port.

16. The method for integrating redundant ring and RSTP according to claim 15, wherein when the mode message is not a transparent mode and the second port closes the RSTP, the second port drops the BPDU.

17. The method for integrating redundant ring and RSTP according to claim 16, wherein when the mode message is not a transparent mode, the BPDU received from one of the two first ports is directly forwarded to the other first port.

18. The method for integrating redundant ring and RSTP according to claim 15, wherein when the transmission source is the second port, embeds the group ID of the second port receiving the BPDU into the BPDU as the group to which the BPDU belongs by the ring node, and compares the group to which the BPDU belongs with a group ID of another second port, and forwards, if a comparison result is inconsistency, the BPDU to the two first ports.

19. The method for integrating redundant ring and RSTP according to claim 15, wherein when the transmission source is one of the two first ports, compares the group to which the BPDU belongs with the group ID of the second port by the ring node, and forwards, if a comparison result is inconsistency, the BPDU to the other first port.

20. The method for integrating redundant ring and RSTP according to claim 15, wherein the mode message and the group ID are set by logging in the ring node and using a preset graphical user interface or instruction.
